(19) United States
(12) Patent Application Publication
(10) Pub. No.: US 2008/0253146 A1
(43) Pub. Date: Oct. 16, 2008

(54) LIGHT UNIFORMING ELEMENT AND ILLUMINATION SYSTEM

(75) Inventor: Sze-Ke Wang, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CORETRONIC CORPORATION, Hsinchu (TW)

(21) Appl. No.: 11/964,016

(22) Filed: Dec. 25, 2007

(30) Foreign Application Priority Data
Apr. 16, 2007 (TW) 96113303

(51) Int. Cl. G02B 5/02

(52) U.S. Cl. 362/558

(57) ABSTRACT

A light uniforming element adapted to an illumination system with multiple lamps is provided. The light uniforming element includes a hollow rod and a plurality of solid rods. The hollow rod has a first light input end and a first light output end opposite to the first light input end. Each of the solid rods has a second light input end and a second light output end opposite to the second light input end. The second light output ends are inserted into the first light input end of the hollow rod. The light outputting efficiency of the light uniforming element is relatively high to improve an image quality of a projection apparatus.

### CROSS-REFERENCE TO RELATED APPLICATION

This application claims the priority benefit of Taiwan application serial no. 96113303, filed on Apr. 16, 2007. The entirety of the above-mentioned patent application is hereby incorporated by reference herein and made a part of this specification.

### BACKGROUND OF THE INVENTION

1. Field of the Invention

The present invention relates to a projection apparatus. More particularly, the present invention relates to a light uniforming element of a projection apparatus.

2. Description of Related Art

Referring to FIG. 1, a conventional projection apparatus 100 includes a lamp 110, a light integration rod 120, a plurality of lenses 130, a light valve 140, and a projection lens 150. The lamp 110 provides an illuminating light beam 112. The light integration rod 120 uniforms the illuminating light beam 112, and the lenses 130 make the illuminating light beam 112 converged on the light valve 140. The light valve 140 converts the illuminating light beam 112 into an image light beam 112′, and the projection lens 150 projects the image light beam 112′ onto a screen (not shown), so as to form an image on the screen.

Generally speaking, the light integration rod 120 is a hollow rod 200 as shown in FIG. 2A or a solid rod 200′ as shown in FIG. 2B. The hollow rod 220 is composed of four reflectors 210, and a reflective coating (not shown) is coated on an inner surface 212 of each of the reflectors 210. Thus, the illuminating light beam 112 is reflected inside the hollow rod 200. As the reflective index of the reflective coatings to visible light is lower than 99%, when the length of the hollow rod 200 increases, the light outputting efficiency becomes lower. Taking the hollow rod 200 having a light input section of 9 mm×6.75 mm as an example, when the length of the hollow rod 200 is 25 mm, the light outputting efficiency is 91.%; when the length of the hollow rod 200 is 54 mm, the light outputting efficiency is only 75.6%. In addition, if the hollow rod 200 is too short, the uniformity of light is reduced, so it is hard to balance between the uniformity of light and the light outputting efficiency.

Moreover, according to the conventional art, the four reflectors 210 are fixed with glues. However, as the illuminating light beam 112 is high in energy, the temperature of the hollow rod 200 (especially the light input end of the hollow rod 200) is often too high. Thus, the glue is deteriorated due to the high temperature, leaving the risk that the hollow rod 200 collapses. Therefore, the hollow rod 200 has poor reliability.

Compared with the hollow rod 200, the solid rod 200′ makes the illuminating light beam 112 reflected internally on the basis of total reflection principle. Therefore, the light outputting efficiency is relatively higher. However, the light output end 202 of the solid rod 200′ is imaged on the light valve 140 directly. If the light output end 200 has defects such as dusts, digs, scratches, or particles, the defects are amplified and projected onto the screen, thus degrading the image quality severely.

### SUMMARY OF THE INVENTION

The present invention is related to a light uniforming element, so as to increase the light outputting efficiency and improve the image quality of a projection apparatus.

The present invention is related to an illumination system with two lamps, so as to increase the light outputting efficiency and improve the image quality of a projection apparatus.

According to one embodiment, a light uniforming element adapted to an illumination system with multiple lamps is provided. The light uniforming element includes a hollow rod and a plurality of solid rods. The hollow rod has a first light input end and a first light output end opposite to the first light input end. Each of the solid rods has a second light input end and a second light output end opposite to the second light input end. The second light output ends are inserted into the first input end of the hollow rod.

According to one embodiment, a light uniforming element adapted to an illumination system with two lamps is further provided. The light uniforming element includes a hollow rod and a solid rod. The hollow rod has a first light input end and a first light output end opposite to the first light input end. The solid rod has a second light input end and a second light output end opposite to the second light input end. The second light output end is inserted into the first input end of the hollow rod. The second light input end is divided into two parts, and two light beams provided by two lamps of the illumination system are incident into the solid rod from one of the two parts of the second light input end respectively.

According to one embodiment, an illumination system with two lamps including two lamps, a light uniforming element, and a light guide element is further provided. The lamps are adapted to provide a light beam respectively. The light guide element is disposed between the lamps and the light uniforming element. The light uniforming element includes a hollow rod and two solid rods. The hollow rod has a first light input end and a first light output end opposite to the first light input end. Each solid rod has a second light input end and a second light output end opposite to the second light input end. The second light output ends are inserted into the first input end of the hollow rod. The light guide element is disposed between the lamps and the second light input ends of the light uniforming element to make the light beams be incident into one of the solid rods respectively.

The light uniforming element of the present invention mainly uses the solid rods to uniform the light beams, so the light outputting efficiency is improved. Moreover, the solid rods are connected with the hollow rod, and thus defects on the surfaces of the second light output ends of the solid rods do not be amplified and projected onto the screen. Thus, the image quality of the projection apparatus is improved.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a conventional projection apparatus.

FIG. 2A is a perspective view of a conventional hollow rod.

FIG. 2B is a perspective view of a conventional solid rod.

FIG. 3 is a schematic cross-sectional view of a light uniforming element according to a first embodiment of the present invention.

FIG. 4 is a diagram illustrating the relationship between the reflective index of a coating of the light uniforming element and the wavelength of visible light.

FIG. 5A is a schematic view of adjusting the angle at which the hollow rod of the light uniforming element is placed.

FIG. 5B is a schematic view of moving the hollow rod of the light uniforming element.

FIG. 6 is a schematic cross-sectional view of another light uniforming element according to the first embodiment of the present invention.

FIG. 7 is a schematic cross-sectional view of a light uniforming element according to a second embodiment of the present invention.

FIG. 8 is a schematic cross-sectional view of a light uniforming element according to a third embodiment of the present invention.

FIG. 9 is a schematic cross-sectional view of a light uniforming element according to a fourth embodiment of the present invention.

FIG. 10 is a schematic cross-sectional view of a light uniforming element according to a fifth embodiment of the present invention.

FIG. 11 is a schematic cross-sectional view of another light uniforming element according to the fifth embodiment of the present invention.

FIG. 12 is a schematic cross-sectional view of a light uniforming element according to a sixth embodiment of the present invention.

FIG. 13 is a schematic cross-sectional view of another light uniforming element according to the sixth embodiment of the present invention.

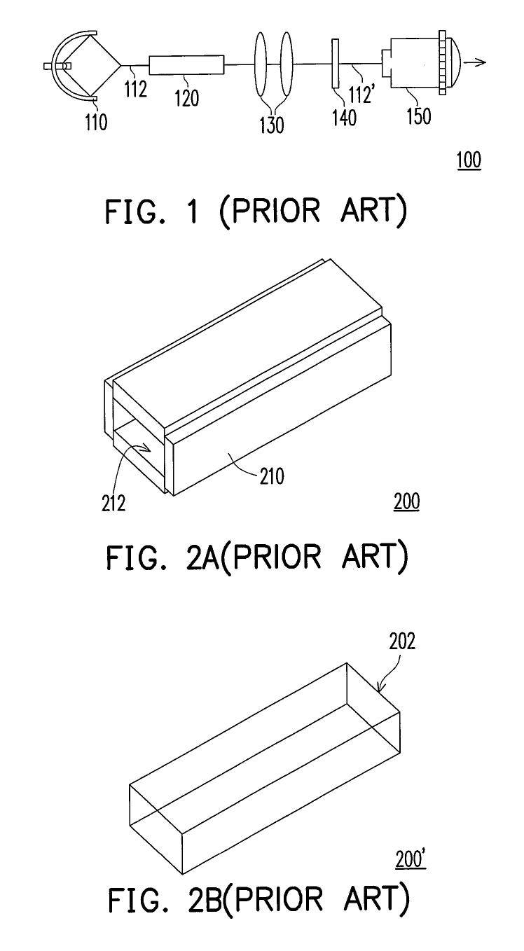

### DESCRIPTION OF EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

### The First Embodiment

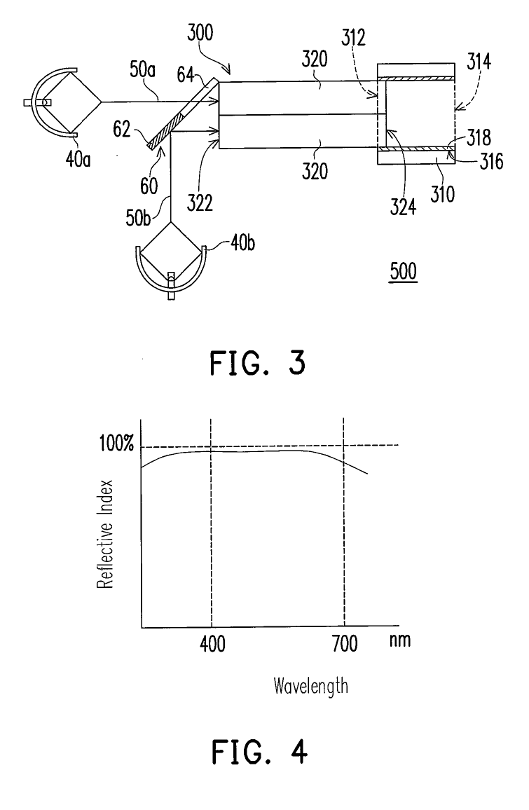

Referring to FIG. 3, an illumination system 500 with two lamps is adapted to be used in a projection apparatus. In this embodiment, the illumination system 500 includes two lamps 40a, 40b and a light uniforming element 300. The light uniforming element 300 includes a hollow rod 310 and two solid rods 320. The hollow rod 310 has a first light input end 312 and a first light output end 314 opposite to the first light input end 312. Each of the solid rods 320 has a second light input end 322 and a second light output end 324 opposite to the second light input end 322. The second light output ends 324 are inserted into the first input end 312 of the hollow rod 310.

Each of the solid rods 320 may be a cylindrical rod or a polygonal prism rod. The polygonal prism rod may be a rectangular parallelepiped rod or a triangular prism rod. In addition, the length of the hollow rod 310 is, for example, smaller than the length of each of the solid rods 320. Moreover, the illumination system 500 further includes a light guide element 60. The two solid rods 320 are disposed between the light guide element 60 and the hollow rod 310, such that light beams 50a, 50b provided by the lamps 40a, 40b of the illumination system 500 are incident into one of the solid rods 320 respectively. In more specific, the light guide element 60 has a transmissive portion 64 and a reflective portion 62. The light beam 50a passes through the transmissive portion 64 and is incident into the upper solid rod 320 in FIG. 3, and the light beam 50b is reflected by the reflective portion 62 and is incident into the lower solid rod 320 in FIG. 3.

As described above, the light beams 50a, 50b after entering the solid rods 320 are totally reflected in the solid rods 320 and become uniform. As the light beams 50a, 50b are totally reflected and no energy is lost, the length of the solid rods 320 is designed to be greater than that of the hollow rod 310 in this embodiment, such that the solid rods 320 become the main light uniforming part in the light uniforming element 300. As the length of the hollow rod 310 is relatively short, the light beams 50a, 50b are reflected in the hollow rod 310 for fewer times, so as to reduce the loss of the light energy. Therefore, as compared with the hollow rod used the conventional art, the light uniforming element 300 of this embodiment improves the light outputting efficiency of the illumination system 500.

Moreover, as the first light output end 314 of the hollow rod 310 serves as the light output end of the light uniforming element 310 in this embodiment, it is prevented that defects such as dusts, digs, scratches, or particles of the second light output ends 324 of the solid rods 320 are imaged on a light valve of the projection apparatus. Therefore, as compared with the solid rod of the conventional art, the light uniforming element 300 of this embodiment improves the image quality of the projection apparatus.

Moreover, as compared with the hollow rod of the conventional art, the second light input ends 322 of the solid rods 320 serve as the light input end of the light uniforming element 310 in this embodiment, so the collapse of the hollow rod caused by the deterioration of the glue at the light input end of the hollow end of the conventional art is prevented. Therefore, the light uniforming element 300 of this embodiment has higher reliability.

Moreover, the second light output ends 324 of the solid rods 320 are inserted into the first light input end 312 of the hollow rod 310 in this embodiment, so the loss of the light beams 50a, 50b at the junction of the solid rods 320 and the hollow rod 310 is prevented, and the light outputting efficiency of the light uniforming element 300 is improved.

In this embodiment and/or other embodiments of the present invention, the hollow rod 310 may have a coating 318 on the inner surface 316 of the hollow rod 310 for reflecting the light beams 50a, 50b. The coating 318 may have different reflective indexes for visible light of different wavelengths (as shown in FIG. 4), so the color temperature of the light beams output from the light uniforming element 300 may be adjusted.

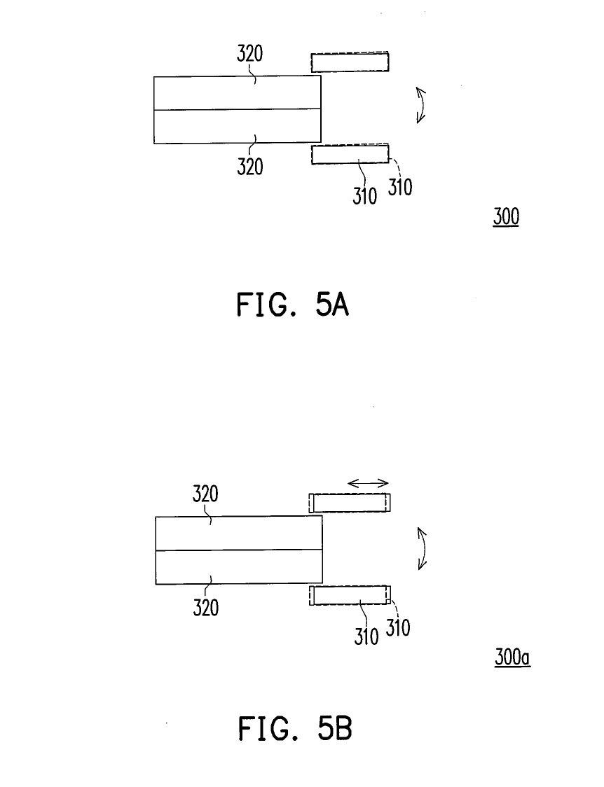

In addition, in this embodiment, the positions that the light beams output from the light uniforming element 300 are projected on the light valve may be fine adjusted with the hollow rod 310. In more specific, in this embodiment, by adjusting the angle at which the hollow rod 310 is placed (as shown in FIG. 5A) or by moving the hollow rod 310 (as shown in FIG. 5B), the light beams may be converged on the light valve precisely, so as to improve the light utilization ratio and the image quality of the projection apparatus. As the solid rods 320 do not move when the hollow rod 310 is adjusted, the positions where the light beams 50a, 50b are input into the light uniforming element 300 are not influenced.

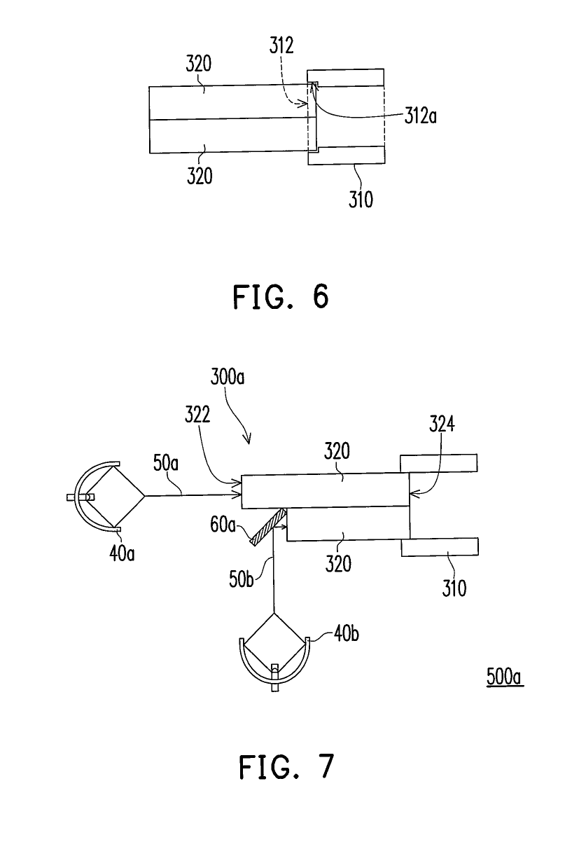

Moreover, referring to FIG. 6, an engaging notch 312a may be arranged near the first light input end 312 of the hollow rod 310, such that the solid rods 310 are inserted in the first light input end 312 more conveniently.

### The Second Embodiment

Referring to FIG. 7, the difference between the light uniforming element 300a and the light uniforming element 300 is that the lengths of the solid rods 320 of the light uniforming element 300a are different. The second light output ends 324 of the solid rods 320 of the light uniforming elements 300a are on a same plane, while the second light input ends 322 of the solid rods 320 are placed on different planes. Moreover, the light guide element 60a of an illumination system 500a with two lamps is a reflective element. The shorter solid rod 320 among the solid rods 320 is disposed between the light guide element 60a and the hollow rod 310, so as to reflect the light beam 50b to the shorter solid rod 320. The light beam 50a is directly incident into the longer solid rod 320.

### The Third Embodiment

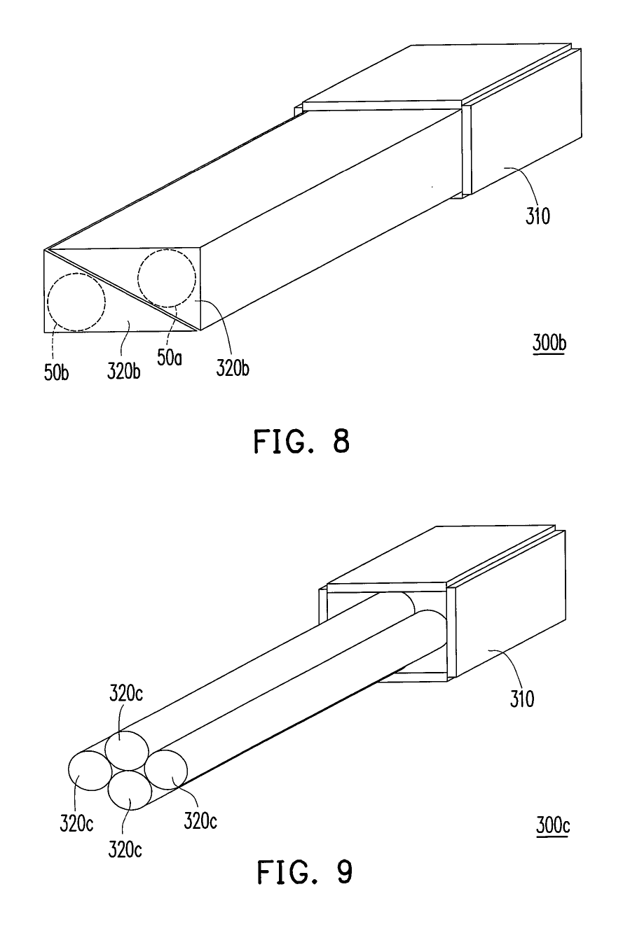

Referring to FIG. 8, the difference between the light uniforming element 300b and the light uniforming element 300 is that the solid rods 320b of the light uniforming element 300b are triangular prism rods, and the two solid rods 320b compose a rectangular parallelepiped rod.

Though the light uniforming elements of the first to the third embodiments include two solid rods respectively, the number of the solid rods is not limited in the present invention. The number of the solid rods of the light uniforming element of the present invention can be adjusted according to the number of the lamps in the illumination system. Next, a light uniforming element having more than two solid rods is illustrated in an embodiment.

### The Fourth Embodiment

Referring to FIG. 9, the difference between the light uniforming element 300c and the light uniforming element 300 is that the light uniforming element 300c includes four solid rods 320c which are cylindrical rods. The light uniforming element 300c is suitable for an illumination system with four lamps. As the light spot of the light beams projected on the solid rods 320 is round, the cylindrical solid rods 320c is adopted to allow most of the light beams to be incident into the solid rods 320c, thereby preventing the loss of the light. Moreover, though the solid rods 320c are cylindrical rods in FIG. 9, the solid rods 320c of this embodiment may be polygonal prism rods as well.

### The Fifth Embodiment

Referring to FIG. 10, a light uniforming element 400 is adapted to an illumination system with two lamps. The light uniforming element 400 includes a hollow rod 410 and a solid rod 420. The hollow rod 410 has a first light input end 412 and a first light output end 414 opposite to the first light input end 412. The solid rod 420 has a second light input end 422 and a second light output end 424 opposite to the second light input end 422. The second light output end 424 is inserted into the first input end 412 of the hollow rod 410. The second light input end 422 is divided into two parts, and two light beams 50a, 50b provided by the two lamps of the illumination system are incident into the solid rod 420 from a corresponding part of the second light input end 422 respectively. In particular, the second light input end 422 has a light reflective surface 423 and a light incident surface 426 adjacent to the light reflective surface 423. The light reflective surface 423 is inclined with respective to the second light output end 424, while the light incident surface 426 is substantially parallel to the second light output end 424.

As described above, the length of the solid rod 420 is, for example, greater than the length of the hollow rod 410. Moreover, the light beam 50a provided by one of the lamps of the illumination system is incident into the solid rod 420 from the light incident surface 426, thus being uniformed in the solid rod 420. After the light beam 50b provided by the other lamp of the illumination system is incident into the solid rod 420 from a side 428 of the solid rod 420, the light beam 50b is reflected by the light reflective surface 423 and is transmitted in a direction towards the second light output end 424. Thus, the light beam 50b is uniformed in the solid rod 420.

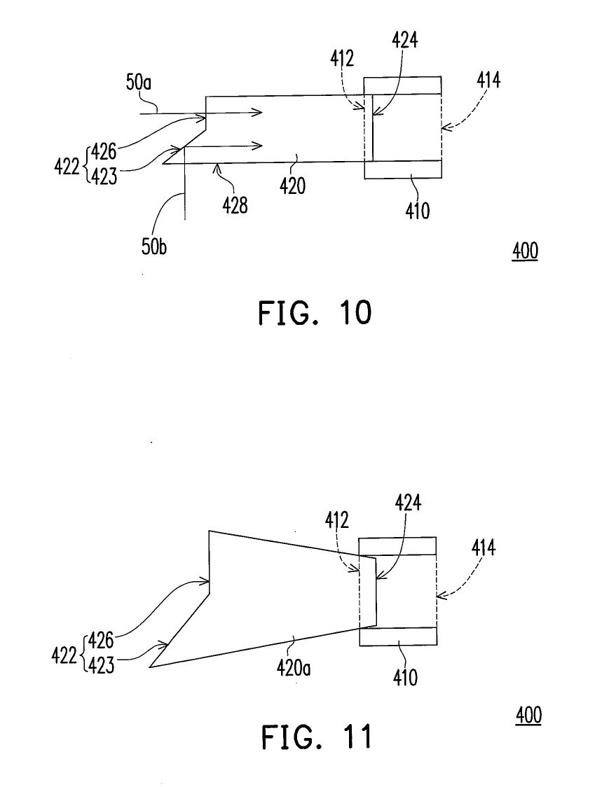

The advantages of the light uniforming element 400 of this embodiment are similar to those of the light uniforming element 300 of the first embodiment, and the details will not be described herein again. In addition, similar to the first embodiment, in this embodiment, an engaging notch 312a as shown in FIG. 6 may also be arranged near the first light input end 412, such that the solid rod 420 is inserted into the first light input end 412 more conveniently. Moreover, in this embodiment, a solid rod 420a (as shown in FIG. 11) that expands gradually from the second light output end 424 to the second light input end 422 may be used, such that the solid rod 420a is inserted into the hollow rod 410 more conveniently.

### The Sixth Embodiment

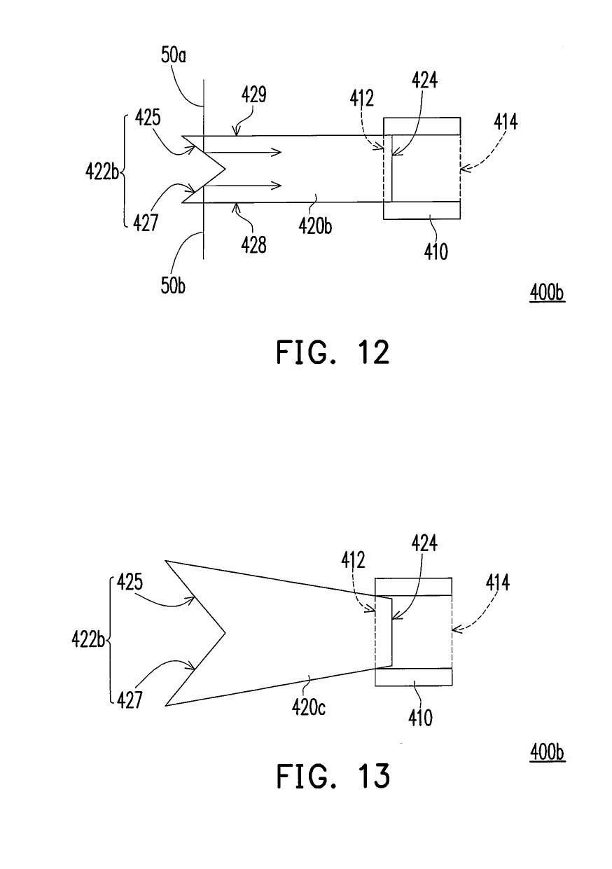

Referring to FIG. 12, the light uniforming element 400b is similar to the light uniforming element 400 of FIG. 10, except that the second light input end 424b of the light uniforming element 400b has two light reflective surfaces 425, 427 between which an angle is formed. After the light beam 50a provided by one lamp of an illumination system with two lamps is incident into the solid rod 420b from a side 429 of the solid rod 420b, the light beam 50a is reflected by the light reflective surface 425 and is transmitted in a direction towards the second light output end 424. Thus, the light beam 50a is uniformed in the solid rod 420. After the light beam 50b provided by the other lamp of the illumination system is incident into the solid rod 420b from a side 428 of the solid rod 420b, the light beam 50b is reflected by the light reflective surface 427 and is transmitted in a direction towards the second light output end 424. Thus, the light beam 50b is uniformed in the solid rod 420.

The advantages of the light uniforming element 400b of this embodiment are similar to those of the light uniforming element 300 of the first embodiment, and the details will not be described herein again. In addition, similar to the first embodiment, in this embodiment, an engaging notch 312a as shown in FIG. 6 may also be arranged near the first light input end 412, such that the solid rod 420b is inserted into the first light input end 412 more conveniently. Moreover, in this embodiment, a solid rod 420c (as shown in FIG. 13) that expands gradually from the second light output end 424 to the second light input end 422 may be used, such that the solid rod 420c is inserted into the hollow rod 410 more conveniently.

To sum up, the embodiments of the present invention have at least one of or a part of or all of the following advantages.

1. The embodiments of the present invention use the solid rod as the main light uniforming part of the light uniforming element, so that the light beam is reflected for fewer times in the hollow rod, thereby reducing the loss of the light energy. Therefore, as compared with the hollow rod of the conventional art, the illumination system with two lamps of the embodiments of the present invention has higher light outputting efficiency.

2. The first light output end of the hollow rod is used as the light output end of the light uniforming element, so the defects of the second light output end of the solid rod are not imaged on the light valve of the projection apparatus. Therefore, as compared with the solid rod of the conventional art, the light uniforming element of the embodiments of the present invention improves the image quality of the projection apparatus.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light uniforming element, adapted to an illumination system with multiple lamps, comprising:
a hollow rod, having a first light input end and a first light output end opposite to the first light input end; and
a plurality of solid rods, each of the solid rods having a second light input end and a second light output end opposite to the second light input end, the second light output ends being inserted into the first light input end of the hollow rod.

2. The light uniforming element as claimed in claim 1, wherein each of the solid rods is a cylindrical rod or a polygonal prism rod.

3. The light uniforming element as claimed in claim 1, wherein the solid rods comprise two triangular prism rods and the triangular prism rods compose a rectangular parallelepiped rod.

4. The light uniforming element as claimed in claim 1, wherein the hollow rod has a coating coated on an inner surface of the hollow rod, and the coating has different reflective indexes for different wavelengths.

5. The light uniforming element as claimed in claim 1, wherein an engaging notch is arranged near the first light input end.

6. The light uniforming element as claimed in claim 1, wherein a length of the hollow rod is smaller than a length of each solid rod.

7. The light uniforming element as claimed in claim 1, wherein the second light input ends are placed on different planes.

8. A light uniforming element, adapted to an illumination system with two lamps, comprising:
a hollow rod, having a first light input end and a first light output end opposite to the first light input end; and
a solid rod, having a second light input end and a second light output end opposite to the second light input end and inserted into the first light input end, the second light input end being divided into two parts, and two light beams provided by two lamps of the illumination system being incident into the solid rod from a corresponding part of the second light input end.

9. The light uniforming element as claimed in claim 8, wherein the second light input end has a light reflective surface and a light incident surface adjacent to the light reflective surface, the light reflective surface is inclined with respect to the second light output end, and the light incident surface is substantially parallel to the second light output end.

10. The light uniforming element as claimed in claim 8, wherein the second light input end has two light reflective surfaces and an angle is formed between the two light reflective surfaces.

11. The light uniforming element as claimed in claim 8, wherein the hollow rod has a coating coated on an inner surface of the hollow rod, and the coating has different reflective indexes for different wavelengths.

12. The light uniforming element as claimed in claim 8, wherein an engaging notch is arranged near the first light input end.

13. The light uniforming element as claimed in claim 8, wherein the solid rod expands gradually to the second light input end from the second light output end.

14. The light uniforming element as claimed in claim 8, wherein a length of the hollow rod is smaller than a length of the solid rod.

15. An illumination system with two lamps, comprising:
two lamps, adapted to provide a light beam respectively;
a light uniforming element, comprising:
a hollow rod, having a first light input end and a first light output end opposite to the first light input end; and
two solid rods, each of the solid rods having a second light input end and a second light output end opposite to the second light input end, the second light output ends being inserted into the first light input end of the hollow rod;
a light guide element, disposed between the lamps and the second light input ends of the light uniforming element to make the light beams be incident into one of the solid rods respectively.

16. The illumination system with multiple lamps as claimed in claim 15, wherein each of the solid rods is a cylindrical rod or a polygonal prism rod.

17. The illumination system with multiple lamps as claimed in claim 15, wherein the solid rods are triangular prism rods and the triangular prism rods compose a rectangular parallelepiped rod.

18. The illumination system with multiple lamps as claimed in claim 15, wherein the hollow rod has a coating coated on an inner surface of the hollow rod, and the coating has different reflective indexes for different wavelengths.

19. The illumination system with multiple lamps as claimed in claim 15, wherein an engaging notch is arranged near the first light input end.

20. The illumination system with multiple lamps as claimed in claim 15, wherein a length of the hollow rod is smaller than a length of each solid rod.

21. The illumination system with multiple lamps as claimed in claim 15, wherein the light guide element has a transmissive portion and a reflective portion, the light beam provided by one of the lamps passes through the transmissive portion and is transmitted to one of the solid rods, and the light beam provided by the other lamp is reflected to the other solid rod by the reflective portion.

22. The light uniforming element as claimed in claim 15, wherein the second light input ends are placed on different planes.

23. The light uniforming element as claimed in claim 22, wherein the light guide element is a reflective element disposed in front of one of the second light input ends.
